(19) United States
(12) Patent Application Publication
(10) Pub. No.: US 2017/0263412 A1
(43) Pub. Date: Sep. 14, 2017

(54) X-RAY TARGET AND X-RAY GENERATION DEVICE HAVING THE SAME

(71) Applicant: SHIMADZU CORPORATION, KYOTO (JP)

(72) Inventor: HIROKI MAEDA, KYOTO (JP)

(73) Assignee: SHIMADZU CORPORATION, KYOTO (JP)

(21) Appl. No.: 15/427,057

(22) Filed: Feb. 8, 2017

(30) Foreign Application Priority Data
Mar. 14, 2016 (JP) 2016-049960

(51) Int. Cl. H01J 35/08

(52) U.S. Cl. CPC H01J 35/08; H01J 2235/12; H01J 2235/081; H01J 2235/186

(57) ABSTRACT

An X-ray target and an X-ray generation device including the X-ray target are provided. In an X-ray target, a frame for supporting an irradiation window is divided into a first frame closer to the irradiation window and a second frame on the outer side of the first frame. The irradiation window is formed of a diamond plate having a thermal expansion coefficient of 1×10⁻⁶/K. The first frame is formed of Mo (molybdenum) having a thermal expansion coefficient of 4.8×10⁻⁶/K or W (tungsten) having a thermal expansion coefficient of 4.3×10⁻⁶/K. The second frame is formed of Cu (copper) having a thermal expansion coefficient of 16.5×10⁻⁶/K. A difference between the thermal expansion coefficients of the irradiation window and the first frame is less than a difference between the thermal expansion coefficients of the irradiation window and the second frame.

### CROSS-REFERENCE TO RELATED APPLICATION

This application claims the priority benefit of Japan application serial no. 2016-049960, filed on Mar. 14, 2016. The entirety of the above-mentioned patent application is hereby incorporated by reference herein and made a part of this specification.

### BACKGROUND OF THE INVENTION

Field of the Invention

The invention relates to an X-ray target including an irradiation window that has a film of a target material formed on a surface thereof, and an X-ray generation device including the X-ray target.

Description of Related Art

Traditionally, there are two types of X-ray generation devices (X-ray tubes), i.e., reflection type as shown in FIG. 2(b) and transmission type as shown in FIG. 2(a). The reflection type irradiates the target with an electron beam B to emit an X-ray (indicated by “Xray” in FIG. 2(a) and FIG. 2(b)) from the target in a direction (e.g., orthogonal direction) different from that of the electron beam B. The transmission type, on the other hand, irradiates the target with the electron beam B, and the X-ray from the target passes through the target to be emitted in the same direction as the electron beam B.

In the case of using the X-ray tube in a micro-focus X-ray inspection device that is capable of observing the inside of a sample nondestructively, it is necessary to put the target, i.e., X-ray source, and the sample as close as possible. For the reflection type, the target and the sample cannot be brought closer to each other due to the distance between a vacuum container housing the target and the target. In contrast thereto, for the transmission type, the irradiation window formed with the film of the target material is attached to the vacuum container, such that the target and the sample can be located close to each other to almost contact each other. As a result, the sample can be observed at a high magnification.

Regarding the target of the transmission type (transmission type target), it is desired that the substrate that supports the target film has low X-ray absorption and good thermal conductivity. Diamond can meet the two requirements and therefore is excellent as the substrate. It has been proposed to use diamond (refer to Patent Literatures 1 and 2, for example). Besides diamond, boron nitride (BN), etc., as disclosed in Patent Literature 2 can also serve as the substrate that meets the two requirements.

Because the irradiation window constitutes a part of the vacuum container, the irradiation window needs to be attached to the vacuum container in an airtight state. However, it is difficult to attach a diamond plate directly to the vacuum container. Thus, a metal frame is brazed to the periphery of the diamond, so as to facilitate attaching the diamond to the vacuum container. For the transmission type, in order to make it easy for X-ray to pass through the target, the diamond plate is a thin film.

Since diamond has a very small thermal expansion coefficient of 1×10⁻⁶/K, if the metal frame has a great thermal expansion coefficient, the thin-film diamond plate may break during the brazing due to the difference in shrinkage caused by thermal expansion difference. Thus, a material having a low thermal expansion coefficient, such as Mo (molybdenum) having a thermal expansion coefficient of 4.8×10⁻⁶/K and W (tungsten) having a thermal expansion coefficient of 4.3×10⁻⁶/K, is used in the metal frame that supports the diamond.

### PRIOR ART LITERATURE

### Patent Literature

Patent Literature 1: Japanese Patent Publication No. H4-144045
Patent Literature 2: Japanese Patent Publication No. H5-343193

### SUMMARY OF THE INVENTION

Nevertheless, use of Mo or W as the metal frame would cause the following problems. That is, when the electron beam hits the transmission type target to generate X-ray, since most of the energy of the electron beam is converted into heat, the temperature of the transmission type target rises. When the transmission type target and the sample are brought into contact for observing the sample at a high magnification, the conventional transmission type target may cause the sample to be damaged by the overheating.

There is a limited space around the transmission type target, and it is difficult to dispose a special cooling mechanism, such as circulating cooling water or installing an air cooling fan. The main heat dissipation mechanism may only release heat to the X-ray tube casing (vacuum container) by thermal conduction of the parts. Thus, the only way to keep the temperature of the transmission type target below the specified temperature is to limit the energy of the electron beam that enters. Setting a limitation to the energy of the electron beam means to limit the amount of X-ray.

As described above, when a material having a low thermal expansion coefficient, such as Mo and W, is used in the metal frame, the aforementioned thermal expansion difference can be solved. However, because the thermal conductivity of Mo is as low as 138 W/m/K and the thermal conductivity of W is as low as 172 W/m/K, it is difficult to release heat to the outside. Therefore, a configuration other than the conventional one is desired for preventing breakage of the irradiation window (the transmission type target itself).

In view of such issues, the invention provides an X-ray target capable of preventing breakage of the irradiation window and an X-ray generation device including the X-ray target.

In view of the above, the invention has the following configuration. That is, an X-ray target of the invention includes an irradiation window having a surface on which a film of a target material is formed; a first frame bonded to the irradiation window and supporting the irradiation window; and a second frame formed of a metal and bonded to the first frame without being bonded to the irradiation window, and supporting the first frame. A difference between thermal expansion coefficients of the irradiation window and the first frame is less than a difference between thermal expansion coefficients of the irradiation window and the second frame.

According to the X-ray target of the invention, a frame for supporting the irradiation window is divided into the first frame (that is bonded to the irradiation window and supports the irradiation window) closer to the irradiation window and the second frame (that is formed of a metal and is not bonded to the irradiation window but bonded to the first frame and supports the first frame), and the first frame and the second frame use different materials. By setting the difference between the thermal expansion coefficients of the irradiation window and the first frame to be less than the difference between the thermal expansion coefficients of the irradiation window and the second frame, breakage of the irradiation window resulting from the difference in shrinkage can be prevented.

In addition, an X-ray generation device of the invention includes the X-ray target of the invention and a container that houses the X-ray target.

According to the X-ray generation device of the invention, the X-ray target capable of preventing breakage of the irradiation window is included, such that an X-ray can be generated without limiting an X-ray amount.

According to the X-ray target of the invention, the difference between the thermal expansion coefficients of the irradiation window and the first frame is set to be less than the difference between the thermal expansion coefficients of the irradiation window and the second frame, such that breakage of the irradiation window resulting from the difference in shrinkage can be prevented.

### BRIEF DESCRIPTION OF THE DRAWINGS

FIG. 1 is a schematic cross-sectional view showing the configuration of an X-ray tube that includes the X-ray target according to an embodiment.

FIG. 2(a) and FIG. 2(b) are schematic cross-sectional views showing the configurations of the conventional X-ray tubes, wherein FIG. 2(b) is the reflection type and FIG. 2(a) is the transmission type.

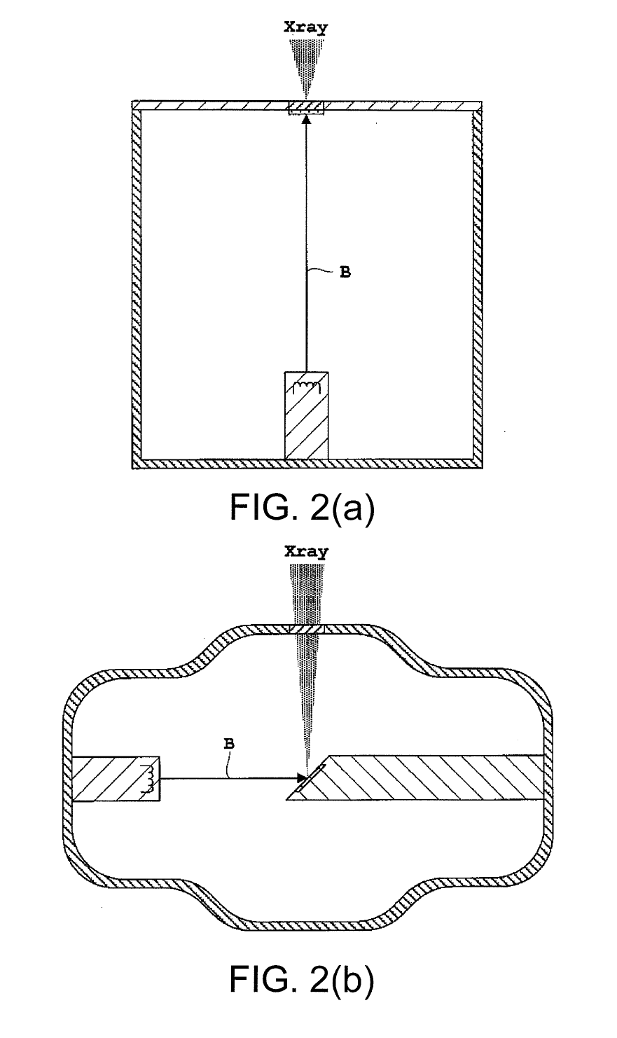

### DESCRIPTION OF THE EMBODIMENTS

### Embodiment 1

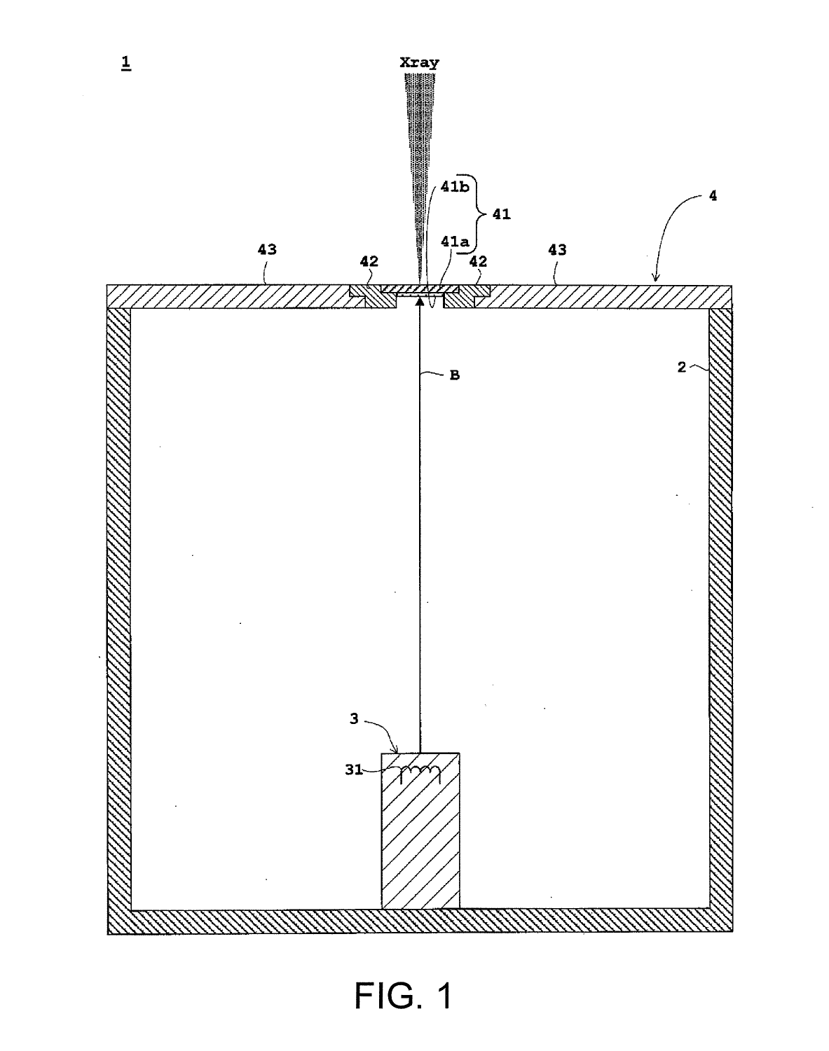

Embodiments of the invention are described hereinafter with reference to the figures. FIG. 1 is a schematic cross-sectional view showing the configuration of an X-ray tube that includes an X-ray target according to an embodiment.

As shown in FIG. 1, an X-ray tube 1 includes a vacuum container 2, a cathode 3, and an X-ray target 4. In addition, an extraction electrode, etc., is also included but is omitted from FIG. 1. The cathode 3 and the X-ray target 4 are housed in the vacuum container 2. The X-ray tube 1 is equivalent to the X-ray generation device of the invention and the vacuum container 2 is equivalent to the container of the invention.

The cathode 3 includes a filament 31, from which an electron beam B is emitted. In this embodiment, a cathode that includes a filament as a thermionic emission type electron gun is described as an example. However, a cathode that includes an emitter formed of a sintered body or a single crystal composed of lanthanum hexaboride (LaB6) or cerium hexaboride (CeB6) may also be used as the thermionic emission type electron gun. Moreover, besides the thermionic emission type electron gun, a field emission type electron gun may be used.

The X-ray target 4 includes an irradiation window 41, a first frame 42 disposed on an outer periphery of the irradiation window 41, and a second frame 43 disposed on a further outer periphery of the first frame 42. The first frame 42 is bonded to the irradiation window 41 and supports the irradiation window 41. The second frame 43 is not directly bonded to the irradiation window 41 but bonded to the first frame 42 and supports the first frame 42. The irradiation window 41 includes a diamond plate 41a and a target material 41b. A film of the target material 41b is formed on a surface (an impact surface of the electron beam B) of the diamond plate 41a. The target material 41b is formed of W (tungsten).

The diamond plate 41a is brazed to the first frame 42 to be supported and the second frame 43 is bonded to the outer periphery of the first frame 42. In this embodiment, the first frame 42 is formed of a metal and is preferably formed of Mo (molybdenum) or W (tungsten). The second frame 43 is formed of a metal as well and is preferably formed of Cu (copper).

A method for bonding the diamond plate 41a and the first frame 42 is preferably brazing, as described above, but not limited thereto, as long as the first frame supports the irradiation window (here, the diamond plate 41a). There are various methods for bonding the first frame 42 and the second frame 43 (such as welding). If the first frame 42 and the second frame 43 are also bonded by brazing, same as the bonding between the diamond plate 41a and the first frame 42 in this embodiment, the three parts (the diamond plate 41a, the first frame 42, and the second frame 43) can be bonded by one process. Therefore, they can be manufactured in an inexpensive way.

As described above, diamond has a thermal expansion coefficient of 1×10⁻⁶/K, Mo has a thermal expansion coefficient of 4.8×10⁻⁶/K, and W has a thermal expansion coefficient of 4.3×10⁻⁶/K. Moreover, Cu has a thermal expansion coefficient of 16.5×10⁻⁶/K. Accordingly, a difference between the thermal expansion coefficient of the irradiation window 41 composed of the diamond plate 41a and the thermal expansion coefficient of the first frame 42 composed of Mo or W is set to be less than a difference between the thermal expansion coefficient of the irradiation window 41 composed of the diamond plate 41a and the thermal expansion coefficient of the second frame 43 composed of Cu. By disposing the diamond plate 41a to be directly supported by the first frame 42 composed of Mo or W that has a low thermal expansion coefficient, breakage of the irradiation window 41 composed of the diamond plate 41a resulting from the difference in shrinkage can be prevented.

Although the difference between the thermal expansion coefficients of the first frame 42 and the second frame 43 is greater than the difference between the thermal expansion coefficients of the irradiation window 41 and the first frame 42, in this embodiment, the first frame 42 and the second frame 43 are formed of metals, and thus, even though the second frame 43 is formed of Cu that has a great thermal expansion coefficient, breakage of the first frame 42 can be prevented by plastic deformation of the metals.

Moreover, as described above, the thermal conductivity of Mo is 138 W/m/K and the thermal conductivity of W is 172 W/m/K. Besides, the thermal conductivity of Cu is 402 W/m/K. Accordingly, the second frame 43 composed of Cu has greater thermal conductivity than the first frame 42 composed of Mo or W. As a result, heat can be easily released to the outside through the second frame 43 on the outer periphery to lower the temperature of the X-ray target 4. Here, a surface area of the second frame 43 is made larger than a surface area of the first frame 42, so as to increase the heat dissipation efficiency of the second frame 43. In addition, when compared under condition of the same temperature, for the X-ray target 4 of this embodiment, it is not required to limit the energy of the electron beam B, and it is possible to increase the X-ray amount.

Further, the first frame 42 is formed of Mo having the thermal expansion coefficient of 4.8×10⁻⁶/K or W having the thermal expansion coefficient of 4.3×10⁻⁶/K and the second frame 43 is formed of Cu having the thermal conductivity of 402 W/m/K. Accordingly, the first frame 42 is composed of a metal having a thermal expansion coefficient of 5×10⁻⁶/K or less and the second frame 43 is composed of a metal having thermal conductivity of 200 W/m/K or more. Consequently, breakage of the irradiation window 41 composed of the diamond plate 41a resulting from the difference in shrinkage can be prevented, and the heat can also be released to the outside through the second frame 43 on the outer periphery to lower the temperature of the X-ray target 4.

According to the X-ray target 4 having the aforementioned configuration, the frame for supporting the irradiation window 41 is divided into the first frame 42 (that is bonded to the irradiation window 41 and supports the irradiation window 41) closer to the irradiation window 41 and the second frame 43 (that is formed of a metal and is not bonded to the irradiation window 41 but bonded to the first frame 42 and supports the first frame 42), and they use different materials. By setting the difference between the thermal expansion coefficients of the irradiation window 41 and the first frame 42 to be less than the difference between the thermal expansion coefficients of the irradiation window 41 and the second frame 42, breakage of the irradiation window 41 resulting from the difference in shrinkage can be prevented. In this embodiment, the first frame 42 is disposed on the outer periphery of the irradiation window 41 and the second frame 43 is disposed on the outer periphery of the first frame 42.

In this embodiment, the irradiation window 41 is diamond and therefore has low X-ray absorption (X-ray is indicated by “Xray” in FIG. 1) and has good thermal conductivity. Accordingly, the X-ray can be emitted with high efficiency and the temperature of the X-ray target 4 can be lowered by the highly thermally conductive diamond.

In addition, the X-ray tube 1 includes the X-ray target 4 that can prevent breakage of the irradiation window 41, by which the X-ray amount can be increased without limiting the energy of the electron beam B, and the X-ray can be generated without limiting the X-ray amount.

The invention is not limited to the embodiment described above and may be modified as follows.

(1) In the above embodiment, the irradiation window 41 is diamond. However, the material is not necessarily diamond if it has good thermal conductivity. For example, SiC (silicon carbide), BN (boron nitride) as disclosed in Patent Literature 2, and so on may be used as the irradiation window as well. Because SiC has good thermal conductivity of 270 W/m/K, SiC can lower the temperature of the X-ray target.

(2) In the above embodiment, the first frame 42 is formed of a metal. However, it is not necessary to use metal to form the first frame 42. For example, the first frame may be formed of SiC (silicon carbide). Because SiC has a low thermal expansion coefficient of 4.5×10⁻⁶/K, it can prevent breakage of the irradiation window (the diamond plate 41a in the embodiment) resulting from the difference in shrinkage. In order to prevent breakage of the first frame, however, it is preferable to use a metal that has a low thermal expansion coefficient (thermal expansion coefficient of 5×10⁻⁶/K or less) to form the first frame, as described in the above embodiment. By forming the first frame with use of the metal, as described in the above embodiment, breakage of the first frame can be prevented by the plastic deformation of the metal.

(3) In the above embodiment, the first frame 42 is formed of Mo or W and the second frame 43 is formed of Cu. However, the materials are not limited to the aforementioned if the difference between the thermal expansion coefficients of the irradiation window and the first frame is less than the difference between the thermal expansion coefficients of the irradiation window and the second frame, and more preferably the second frame has greater thermal conductivity than the first frame. For example, the second frame may be formed of Al (aluminum). Because Al has a thermal expansion coefficient of 23×10⁻⁶/K, the difference between the thermal expansion coefficients of the irradiation window composed of the diamond plate and the first frame composed of Mo or W is less than the difference between the thermal expansion coefficients of the irradiation window composed of the diamond plate and the second frame composed of Al. Moreover, Al has thermal conductivity of 200 W/m/K or more. Thus, the second frame composed of Al has greater thermal conductivity than the first frame composed of Mo or W. As a result, the heat can be easily released to the outside through the second frame on the outer periphery and the temperature of the X-ray target can be lowered.

(4) In the above embodiment, in the case where the irradiation window 41 is diamond, the first frame 42 is composed of a metal having a thermal expansion coefficient of 5×10⁻⁶/K or less and the second frame 43 is composed of a metal having thermal conductivity of 200 W/m/K or more. However, the thermal expansion coefficient or the thermal conductivity is not limited to the aforementioned range. The material of the first frame or the second frame is selected in order than the thermal expansion coefficient or the thermal conductivity satisfies the specified range corresponding to the material of the irradiation window.

(5) In the above embodiment, the first frame 42 is disposed on the outer periphery of the irradiation window 41 and the second frame 43 is disposed on the outer periphery of the first frame 42. However, the second frame 43 is not necessarily disposed on the outer periphery of the first frame 42. If the structure is made such that the first frame is bonded to the irradiation window and supports the irradiation window and the second frame made of a metal is not bonded to the irradiation window but bonded to the first frame and supports the first frame, the structure may be formed by lamination in the order of the irradiation window, the first frame, and the second frame.

As described above, the invention is suitable for the X-ray target and X-ray generation device for industrial use or medical use.

What is claimed is:

1. An X-ray target, comprising:
an irradiation window having a surface on which a film of a target material is formed;
a first frame bonded to the irradiation window and supporting the irradiation window; and
a second frame formed of a metal and bonded to the first frame without being bonded to the irradiation window, and supporting the first frame,
wherein a difference between thermal expansion coefficients of the irradiation window and the first frame is less than a difference between thermal expansion coefficients of the irradiation window and the second frame.

2. The X-ray target according to claim 1, wherein the first frame is disposed on an outer periphery of the irradiation window and the second frame is disposed on an outer periphery of the first frame.

3. The X-ray target according to claim 1, wherein the second frame has greater thermal conductivity than the first frame.

4. The X-ray target according to claim 1, wherein the first frame is composed of a metal having a thermal expansion coefficient of 5×10⁻⁶/K or less and the second frame is composed of a metal having thermal conductivity of 200 W/m/K or more.

5. The X-ray target according to claim 1, wherein the first frame is formed of tungsten or molybdenum and the second frame is formed of copper.

6. The X-ray target according to claim 1, wherein the irradiation window is diamond.

7. An X-ray generation device, comprising:
the X-ray target according to claim 1; and
a container housing the X-ray target.

8. An X-ray generation device, comprising:
the X-ray target according to claim 2; and
a container housing the X-ray target.

9. An X-ray generation device, comprising:
the X-ray target according to claim 3; and
a container housing the X-ray target.

10. An X-ray generation device, comprising:
the X-ray target according to claim 4; and
a container housing the X-ray target.

11. An X-ray generation device, comprising:
the X-ray target according to claim 5; and
a container housing the X-ray target.

12. An X-ray generation device, comprising:
the X-ray target according to claim 6; and
a container housing the X-ray target.
